(19) United States
(12) Patent Application Publication
(10) Pub. No.: US 2020/0106150 A1
(43) Pub. Date: Apr. 2, 2020

(54) Microwave isolation device

(71) Applicant: Sichuan University, Chengdu (CN)

(72) Inventors: Huacheng Zhu, Chengdu (CN); Kama Huang, Chengdu (CN); Yang Yang, Chengdu (CN)

(73) Assignee: Sichuan University

(21) Appl. No.: 16/699,605

(22) Filed: Nov. 30, 2019

(30) Foreign Application Priority Data
Mar. 8, 2019 (CN) 201910175288.9

(51) Int. Cl. H01P 1/36

(52) U.S. Cl. CPC H01P 1/36

(57) ABSTRACT

A microwave isolation device includes a waveguide, two flanges respectively located at two ends of the waveguide, and a super interface, wherein an upper side and a lower side of the waveguide are connected with the super interface. The microwave isolation device is able to replace the traditional microwave power protection and efficiency enhancing device. It not only protects the microwave power supply, but also improves the utilization of microwave energy, and solves the problems that the traditional protection device has too small power capacity and low efficiency, and traditional efficiency enhancing devices are difficult to be deployed and have a blind zone for deployment. Compared with the three pins, the non-reciprocal transmission isolator has characteristics of no dynamic adjustment and simple system composition. Compared with circulators and isolators, the present invention improves the energy utilization rate to meet the needs of high-power microwave devices in various fields.

### CROSS REFERENCE OF RELATED APPLICATION

The present invention claims priority under 35 U.S.C. 119(a-d) to CN 201910175288.9, filed Mar. 8, 2019.

### BACKGROUND OF THE PRESENT INVENTION

### Field of Invention

The present invention relates to the field of microwave energy technology, and more particularly to a microwave isolation device using metamaterials for single microwave transmission.

### Description of Related Arts

As an efficient clean energy source, microwave energy has the characteristics of high efficiency, energy saving, selective heating, clean and pollution-free, and has wide applications in food processing, chemical industry and medicine. Especially in the two high-energy-consuming industries of chemical industry and metallurgy, microwave applications show significant advantages in energy saving and emission reduction. With the development of science, microwave isolation devices have developed to a large extent, and its development has brought great convenience to the efficient clean energy and its variety and quantity are increasing. Although there are many types and quantities of microwave isolation devices on the market, most of the microwave isolation devices have low capacity and complicated structure, and are low in the energy utilization rate due to easy damage. In addition, because the adjustment process is complicated and there is a blind zone for deployment, the response speed is slow and the reflection suddenly changes during the mediation process. Therefore, there is an urgent need in the market for technologies that can improve the structure of microwave isolation devices to improve the device.

### SUMMARY OF THE PRESENT INVENTION

An object of the present invention is to provide a novel microwave isolation device, so as to solve the problems that in the background art described above, the microwave isolation devices currently on the market have a low capacity and a complicated structure; at the same time, the use of microwave circulators leads to low energy utilization and easy damage, in addition, the process of three-pin matching is complicated and there is a deployment blind spot, the response speed is slow and the reflection suddenly changes during the mediation process.

In order to achieve the above object, the present invention provides a technical solution as follows.

A microwave isolation device comprises a waveguide, two flanges respectively located at two ends of the waveguide, and a super interface, wherein an upper side and a lower side of the waveguide are connected with the super interface.

Preferably, the super interface has a thickness of 2 mm, and is made from a special composite material with extraordinary physical properties not found in traditional materials.

Preferably, when an electromagnetic wave encounters the super interface, a phase is suddenly changed and is continuously changed in an interface orientation; the electromagnetic wave passes through the super interface for many times and is gradually changed into a surface wave, thereby realizing a single-permeability propagation of the electromagnetic wave; the super interface is obtained by using a weakening device; the electromagnetic wave satisfies a following distribution on the super interface with a graded refractive index of

for TE (transverse electric field) wave,

$$∇ \times ( \frac{1}{{μ}_{0} μ ( x )} ∇ \times \vec{E} ) = {ω}^{2} {ɛ}_{0} ɛ ( x ) \vec{E} ,$$

wherein, z,900 represents an electric field intensity, ε represents a dielectric constant, μ represents a magnetic conductivity, ε₀ represents a vacuum dielectric constant, and ω is the angular frequency.

Preferably, the super interface ensures that a tensor of capacitance is as same as a tensor of magnetic conductivity through weakening and sacrificing a part of functions of the device in a certain form; the dielectric constant and the magnetic conductivity of the super interface with the graded refractive index are expressed by a formula of

$${ɛ}^{′} ( x ) = {n ( x )}^{2} = {[ 1 + \frac{κ ( x - {x}_{0} )}{2 {k}_{0} d} ]}^{2} ,$$

wherein, k, d and k₀ represent parameters related to the design of asymmetric transmission waveguides, x represents a position of a point in the waveguide, x₀ represents the position of the initial reference point in the waveguide, n represents a refractive index of the super interface.

Compared with the prior art, the beneficial effects of the present invention are as follows.

(1) The microwave isolation device provided by the present invention has a super interface made from a special composite material with extraordinary physical properties not found in traditional materials, which not only protects the microwave power supply, but also improves the utilization of microwave energy, and solves the problems that the traditional protection device has too small power capacity and low efficiency, and traditional efficiency enhancing devices are difficult to be deployed and have a blind zone for deployment.

(2) The microwave isolation device provided by the present invention has a super interface to ensure that a tensor of capacitance is as same as a tensor of magnetic conductivity through weakening and sacrificing a part of functions of the device in a certain form; compared with the three pins, the non-reciprocal transmission isolator has characteristics of no dynamic adjustment and simple system composition.

(3) In the present invention, the electromagnetic wave passes through the super interface for many times and is gradually changed into a surface wave, thereby realizing a single-permeability propagation of the electromagnetic wave; compared with circulators and isolators, the present invention improves the energy utilization rate; the microwave isolation device provided by the present invention is able to be manufactured using 3D printing, has low manufacturing cost, easy mass production and processing, low temperature during use, and long life, which meets the needs of high-power microwave devices in various fields.

### BRIEF DESCRIPTION OF THE DRAWINGS

FIG. 1 is a structurally schematic view of the present invention.

FIG. 2 is a local model diagram of a super interface of the present invention.

In the drawings, 1: standard flange; 2: waveguide; 3: super interface.

### DETAILED DESCRIPTION OF THE PREFERRED EMBODIMENT

The technical solution in the embodiment of the present invention is clearly and completely described with accompanying drawings as follows. It is obvious that the described embodiment is only a part of the embodiments of the present invention, but not all embodiments. All other embodiments obtained by those skilled in the art based on the embodiment of the present invention without creative efforts are within the scope of the present invention.

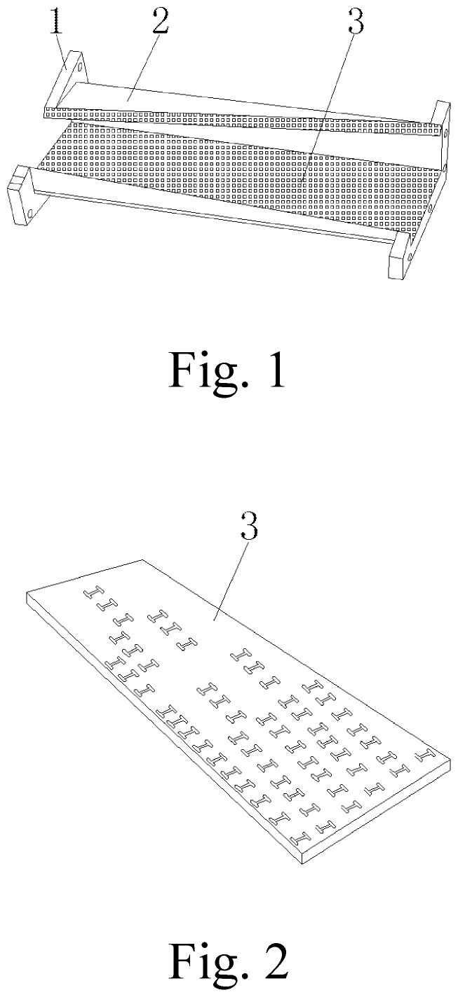

Referring to FIGS. 1 to 2, a microwave isolation device according to a preferred embodiment of the present invention is illustrated, which comprises two standard flanges 1, a waveguide 2 and a super interface 3, wherein the two standard flanges 1 are respectively located at two ends of the waveguide 2, and an upper side and a lower side of the waveguide 2 are respectively connected with the super interface 3.

Preferably, the super interface 3 has a thickness of about 2 mm, and is made from a special composite material with extraordinary physical properties not found in traditional materials. This remarkable physical property is manifested in the one-way transmission of electromagnetic waves in waveguides.

Preferably, when an electromagnetic wave encounters the super interface 3, a phase is suddenly changed and is continuously changed in an interface orientation; the electromagnetic wave passes through the super interface 3 for many times and is gradually changed into a surface wave, thereby realizing a single-permeability propagation of the electromagnetic wave. The super interface 3 is obtained by using a weakening device. The electromagnetic wave satisfies a following distribution on the super interface 3 with a graded refractive index of

for TE (transverse electric field) wave,

$$∇ \times ( \frac{1}{{μ}_{0} μ ( x )} ∇ \times \vec{E} ) = {ω}^{2} {ɛ}_{0} ɛ ( x ) \vec{E} ,$$

wherein, z,900 represents an electric field intensity, ε represents a dielectric constant, μ represents a magnetic conductivity, ε₀ represents a vacuum dielectric constant.

Preferably, the super interface 3 ensures that a tensor of capacitance is as same as a tensor of magnetic conductivity through weakening and sacrificing a part of functions of the device in a certain form; the dielectric constant and the magnetic conductivity of the super interface with the graded refractive index are expressed by a formula of

$${ɛ}^{′} ( x ) = {n ( x )}^{2} = {[ 1 + \frac{κ ( x - {x}_{0} )}{2 {k}_{0} d} ]}^{2} ,$$

wherein, k, d and k₀ represent parameters related to the design of asymmetric transmission waveguides, x represents a position of a point in the waveguide, x₀ represents the position of the initial reference point in the waveguide, n represents a refractive index of the super interface.

Although the present invention has been described in detail with reference to the foregoing embodiment, those skilled in the art may still modify the technical solution described in the foregoing embodiment, or equivalently replace some of the technical features. Any modifications, equivalent substitutions and improvements within the spirit and scope of the present invention are intended to be included within the protective scope of the present invention.

What is claimed is:

1. A microwave isolation device, which comprises two standard flanges (1), a waveguide (2) and a super interface (3), wherein the two standard flanges (1) are respectively located at two ends of the waveguide (2), and an upper side and a lower side of the waveguide (2) are respectively connected with the super interface (3).

2. The microwave isolation device, as recited in claim 1, wherein the super interface (3) has a thickness of 2 mm, and is made from a special composite material with extraordinary physical properties not found in traditional materials.

3. The microwave isolation device, as recited in claim 1, wherein when an electromagnetic wave encounters the super interface (3), a phase is suddenly changed and is continuously changed in an interface orientation; the electromagnetic wave passes through the super interface (3) for many times and is gradually changed into a surface wave, thereby realizing a single-permeability propagation of the electromagnetic wave; the super interface (3) is obtained by using a weakening device; the electromagnetic wave satisfies a following distribution on the super interface (3) with a graded refractive index of
for TE (transverse electric field) wave,
$$∇ \times ( \frac{1}{{μ}_{0} μ ( x )} ∇ \times \vec{E} ) = {ω}^{2} {ɛ}_{0} ɛ ( x ) \vec{E} ,$$
wherein, z,900 represents an electric field intensity, ε represents a dielectric constant, μ represents a magnetic conductivity, ε₀ represents a vacuum dielectric constant.

4. The microwave isolation device, as recited in claim 1, wherein the super interface (3) ensures that a tensor of capacitance is as same as a tensor of magnetic conductivity through weakening and sacrificing a part of functions of the device in a certain form; the dielectric constant and the magnetic conductivity of the super interface with the graded refractive index are expressed by a formula of
$${ɛ}^{′} ( x ) = {n ( x )}^{2} = {[ 1 + \frac{κ ( x - {x}_{0} )}{2 {k}_{0} d} ]}^{2} ,$$
wherein, k represents a parameter related to the design of asymmetric transmission waveguides, x represents a position of a point in the waveguide, x₀ represents a position of an initial reference point in the waveguide, n represents a refractive index of the super interface.
